(19) United States
(12) Patent Application Publication
(10) Pub. No.: US 2009/0058760 A1
(43) Pub. Date: Mar. 5, 2009

(54) MOBILE PANEL-TYPE OUTDOOR BILLBOARD AND NEON SIGNBOARD

(76) Inventor: Yoshio AOKI, Chiba-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/202,573

(22) Filed: Sep. 2, 2008

(30) Foreign Application Priority Data
Sep. 3, 2007 (JP) 2007-7599

(51) Int. Cl. G09G 5/00

(52) U.S. Cl. 345/1.3; 345/211

(57) ABSTRACT

A mobile panel-type outdoor billboard and a neon signboard each include a large mobile panel and a solar power generator connected by an electric wire to the large mobile panel. The large mobile panel is composed of a single large panel formed by assembling a plurality of liquid crystal panels and light-emitting diode panels. The large panel is provided with a built-in function device that has an IC chip or memory card insertion function and a short-distance wireless function or a mobile phone function. By operating a switch button on a mobile phone pointed towards the liquid crystal panels or light-emitting diode panels, the design of the advertisement or neon sign can be instantaneously changed.

### BACKGROUND OF THE INVENTION

1. Field of the Invention

The present invention relates to mobile panel-type outdoor billboards and neon signboards that substitute for the currently used outdoor advertisements and neon signs, and which are provided by connecting a plurality of liquid crystal panels or light-emitting diode panels to constitute a large mobile panel, and by installing a solar power generator on a side wall, a rooftop, or the like of a building, in order to supply the power consumed by the panel.

2. Prior Art

The conventionally known large outdoor billboards and large neon signs with a mobile function have generally required high-voltage electric power, and hence considerable electric costs. Moreover, changing designs and the like has necessitated considerable time and effort, along with a vast expense. In addition, changing pictures and screens has often involved some danger because it requires working at high and dangerous places, or the construction of large signboards.

### SUMMARY OF THE INVENTION

An object of the present invention is to provide a mobile panel-type billboard and a neon signboard which includes, separately from a large liquid crystal panel, a solar power generator equipped with a storage battery device, to supply the power consumed by the large liquid crystal panel, in order to solve the above-described prior art defects.

Another object of the invention is to provide a mobile panel-type outdoor billboard and a neon signboard, wherein a plurality of light-emitting diode panels or liquid crystal panels are assembled into a single large panel; the large panel contains input information such as designs and the like of advertisements and neon signs; and the information that is input into the large panel such as designs and the like of advertisements and neon signs can be easily changed externally through a mobile phone or the like.

In order to achieve the above-mentioned objects, the mobile panel-type outdoor billboard and the neon signboard of the present invention comprise a solar power generator that incorporates a storage battery device therein, and a large mobile panel connected by an electric wire to the solar power generator, wherein the large mobile panel is provided with several tens of liquid crystal panels or light-emitting diode panels assembled into a single large panel, and each liquid crystal panel or light-emitting diode panel includes a built-in function device having an IC chip or memory card insertion function provided with an IC chip or a memory card, and a short-distance wireless function or a mobile phone function for operating the IC chip or memory card. In addition, each liquid crystal panel has a coordination and adjustment function so that the liquid crystal panels or the like display an image, a photograph, or the like as a single large panel, to form a single picture.

According to the present invention, information such as designs and the like of advertisements or neon signs that has been input into an IC chip or a memory card of the built-in function device attached to the large mobile panel is displayed on the large mobile panel, and information can be externally transmitted through a wireless device or a mobile phone to the built-in function device, to thereby easily change the design and the like of the advertisement or neon sign on the large mobile panel. The outdoor billboard and the large neon signboard can therefore be used all day long. Moreover, a solar power generator is installed on a side wall or a rooftop of a building, thereby supplying sufficient power consumed by the large mobile panel. In addition, the formation of a single large mobile panel using a plurality of liquid crystal panels enables the advertising tower to be instantaneously changed through easy operation, and also enables many advertisements to be made, thus leading to high advertising profits from the large mobile panel. Furthermore, light-emitting diode panels exhibit high luminance and high visibility, and therefore provide significant advertising effects. They also typically consume only about 30% of electricity, and therefore aid in energy savings.

### BRIEF DESCRIPTION OF THE DRAWINGS

FIG. 1 is a front view illustrating a mobile panel-type outdoor billboard and neon signboard of the present invention.

### DETAILED DESCRIPTION OF THE PREFERRED EMBODIMENT

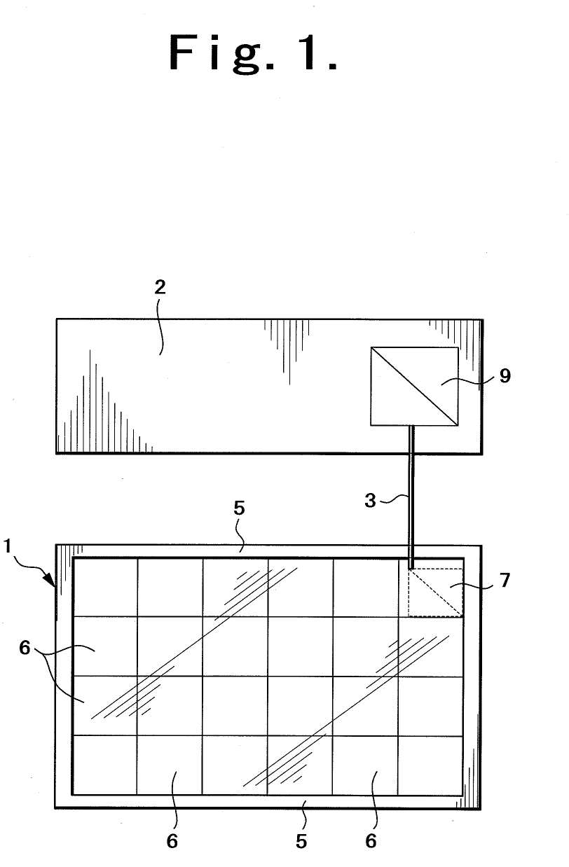

An embodiment of the invention is described with reference to the attached drawing. As illustrated in FIG. 1, the mobile pane-type outdoor billboard and neon signboard of the invention include a large mobile panel 1, and a solar power generator 2 connected by an electric wire 3 to the large mobile panel 1. The solar power generator 2 is located on a side wall or a rooftop of a building, and incorporates therein a storage battery device 9 in a predetermined position, so as to supply electricity to the large mobile panel 1 from the storage battery device 9 via the electric wire 3. Similarly with the solar power generator 2, the large mobile panel 1 is located on a side wall or a rooftop of a building, and is formed by assembling several tens of liquid crystal panels or light-emitting diodes 6 into a single large panel. FIG. 1 shows a large mobile panel 1 constructed by using twenty-four liquid crystal panels 6 arranged inside an outer frame 5.

A built-in function device 7 is disposed in the interior of each liquid crystal panel or light-emitting diode panel 6 arranged in inside of the outer frame 5 of the large mobile panel 1, and has an IC chip insertion function or a memory card insertion function, and a short-distance wireless function or a mobile phone function connected to the IC chip or memory card insertion function. The IC chip or memory card insertion function of the built-in function device 7 includes an IC chip or a memory card that contains input information such as characters, designs, images, photographs, and the like of advertisements or neon signs for display on the large mobile panel 1. The short-distance wireless function or mobile phone function of the built-in function device 7 includes a switch for changing the characters, designs, images, photographs, or the like of advertisements or neon signs for display on the large mobile panel 1, and an on/off switch for advertisements or neon signs.

In order to display the design, image, or photograph of an advertisement or a neon sign on the large mobile panel 1 through the plurality of liquid crystal panels or light-emitting diode panels 6, the large mobile panel 1 is provided with a coordination and adjustment function arranged between the plurality of the liquid crystal panels or light-emitting diodes 6, said coordination and adjustment function enables the plurality of the liquid crystal panels or light-emitting diodes 6 to be associated to each other to display a single picture jointly on the plurality of the liquid crystal panes or light-emitting diodes 6.

The IC chip or memory card insertion function and the short-distance wireless function or mobile phone function of the built-in function device 7 can be operated by a short-distance wireless device or a mobile phone which can transmitted from the outside toward each liquid crystal panel or light-emitting diode panel 6, to display the characters, design, image, or photograph of an advertisement or a neon sign, and also to instantaneously change the item being displayed.

What is claimed is:

1. A mobile panel-type outdoor billboard comprising a large mobile panel and a solar power generator connected by an electric wire to the large mobile panel, characterized in that the solar power generator includes a storage battery device, the large mobile panel is provided with a plurality of liquid crystal panels or light-emitting diode panels disposed in the inside of an outer frame, each liquid crystal panel or light-emitting diode panel is provided with a built-in function device having an IC chip or memory card insertion function and a short-distance wireless function or a mobile phone function, and the liquid crystal panels or light-emitting diode panels are connected to one another so as to form a single large panel to display a picture.

2. A mobile panel-type neon signboard comprising a large mobile panel and a solar power generator connected by an electric wire to the large mobile panel, characterized in that the solar power generator includes a storage battery device, the large mobile panel is provided with a plurality of liquid crystal panels or light-emitting diode panels disposed in the inside of an outer frame, each liquid crystal panel or light-emitting diode panel is provided with a built-in function device having an IC chip or memory card insertion function and a short-distance wireless function or a mobile phone function, and the liquid crystal panels or light-emitting diode panels are connected to one another so as to form a single large panel to display a picture.
